(19) United States
(12) Patent Application Publication
(10) Pub. No.: US 2021/0349457 A1
(43) Pub. Date: Nov. 11, 2021

(54) VEHICLE CONTROLLER FOR AUTOMATED DRIVING VEHICLE, VEHICLE DISPATCHING SYSTEM, AND VEHICLE DISPATCHING METHOD

(71) Applicant: Toyota Jidosha Kabushiki Kaisha, Toyota-shi Aichi-ken (JP)

(72) Inventors: Kentaro Ichikawa, Shizuoka-ken (JP); Akihide Tachibana, Tokyo-to (JP); Hiroshi Nakamura, Tokyo-to (JP); Taisuke Sugaiwa, Tokyo-to (JP); Katsuhiro Sakai, Kawasaki-shi (JP)

(21) Appl. No.: 17/237,209

(22) Filed: Apr. 22, 2021

(30) Foreign Application Priority Data
May 7, 2020 (JP) 2020-081912

(51) Int. Cl. G05D 1/00; G05D 1/02; B60W 60/00

(52) U.S. Cl. CPC G05D 1/0011; G05D 1/0212; B60W 2556/45; B60W 2420/42; B60W 60/00253

(57) ABSTRACT

A vehicle controller of the automated driving vehicle capable of driverless transportation is connected with a user terminal via a communication network. The user terminal includes a terminal camera which a user who is at a desired dispatch location possesses. The automated driving vehicle includes an in-vehicle camera to capture a surrounding situation. The vehicle controller receives, from the user terminal via the communication network, a terminal camera image captured by the terminal camera from the desired dispatch location. Then, the vehicle controller identifies an image area that matches the terminal camera image from an in-vehicle camera image captured by the in-vehicle camera, and determines a pickup position capable of stopping based on positional coordinates information of the image area.

### CROSS-REFERENCE TO RELATED APPLICATION

The present application claims priority under 35 U.S.C. § 119 to Japanese Patent Application No. 2020-081912, filed May 7, 2020, the contents of which application are incorporated herein by reference in their entirety.

### BACKGROUND

### Field

The present disclosure relates to a vehicle controller for an automated driving vehicle, a vehicle dispatching system, and a vehicle dispatching method.

### Background Art

International Publication No. WO2019/065696 discloses a technique related to a vehicle dispatching service of an automated driving vehicle. The automated driving vehicle of this technology receives dispatch request information from a user. The dispatch request information includes information relating to a dispatch location (i.e., destination), such as, current user position information acquired by a user terminal from GPS (Global Positioning System). The automated driving vehicle determines a stop place at a destination included in the dispatch request information. At this time, the automated driving vehicle reads a feature data relating to features of the destination, and determines the stop place based on the user information included in the dispatch request information.

### SUMMARY

A facility such as a hotel, a building, a station, an airport, and the like is provided with a pick-up and drop-off area in which the automated driving vehicle stops to pick up or drop off the user. In the case of specifying a dispatch location desired by a user in a crowded pick-up and drop-off area, it is conceivable to use the user position information acquired by using the GPS function of a user terminal owned by a user. In this case, there is a possibility that accurate position information may not be obtained due to errors in the GPS function. Thus, the art for accurately stopping the automated driving vehicle to the dispatch position desired by the user in the pick-up and drop-off area, there remains room for improvement.

The present disclosure has been made in view of the above-described problems, and an object thereof is to provide a vehicle controller for an automated driving vehicle, a vehicle dispatching system, and a vehicle dispatching method capable of determining an appropriate pick-up position in a pick-up and drop-off area in which the automated driving vehicle stops to pick up or drop off a user.

In order to solve the above problems, the first disclosure is applied to a vehicle controller for an automated driving vehicle capable of driverless transportation, which is connected via a communication network to a user terminal with a terminal camera owned by a user who is at a desired dispatch location. The automated driving vehicle includes an in-vehicle camera to capture a surrounding situation. The vehicle controller includes at least one processor and at least one memory. The at least one memory includes at least one program that causes the at least one processor to execute first processing and second processing. In the first processing, the at least one program causes the at least one processor to receive a terminal camera image, which is captured by the terminal camera at the desired dispatch location, from the user terminal via the communication network. In the second processing, the at least one program causes the at least one processor to identify an image area that matches the terminal camera image from an in-vehicle camera image captured by the in-vehicle camera, and to determine a pickup position capable of stopping based on positional coordinates information of the image area.

The second disclosure has the following features in the first disclosure.

The terminal camera image is a user image obtained by capturing the user. In the second processing, the at least one program causes the at least one processor to specify the image area as the desired dispatch location where the user is present, and to determine a stoppable position close to the desired dispatch location as the pickup position.

The third disclosure has the following features in the first disclosure.

The terminal camera image is a surrounding environment image obtained by capturing a surrounding environment of the desired dispatch location. In the second processing, the at least one program causes the at least one processor to specify the desired dispatch location based on positional coordinate information of the image area, and to determine a stoppable position close to the desired dispatch location as the pickup position.

The fourth disclosure has the following features in the first disclosure.

The at least one program causes the at least one processor to execute third processing of recognizing that the automated driving vehicle has approached the desired dispatch location, and fourth processing of sending a notification to the user terminal to prompt the user to capture the terminal camera image when the automated driving vehicle approaches the desired dispatch location.

The fifth disclosure has the following features in the fourth disclosure.

In the third processing, the at least one program causes the at least one processor to recognize that the automated driving vehicle approaches the desired dispatch location when the automated driving vehicle enters a pick-up and drop-off area used by the user.

The sixth disclosure has the following features in the fourth disclosure.

The at least one program causes the at least one processor to execute fifth processing of reducing a maximum allowable speed of the automated driving vehicle compared to before approaching the desired dispatch location, when the automated driving vehicle approaches the desired dispatch location.

The seventh disclosure has the following features in the first disclosure.

The at least one program causes the at least one processor to execute sixth processing of transmitting information related to the pickup position to the user terminal.

The eighth disclosure is applied to a vehicle dispatching system includes an automated driving vehicle capable of driverless transportation, a user terminal owned by a user who is at a desired dispatch location, and a management server to communicate with the automated driving vehicle and the user terminal via a communication network. The user terminal includes a terminal camera, and a user terminal controller to control the user terminal. The user terminal controller is programmed to execute processing of transmitting a terminal camera image, which is captured by the terminal camera at the desired dispatch location, to the management server. The automated driving vehicle includes an in-vehicle camera to capture a surrounding situation of the automated driving vehicle, and a vehicle controller to control the automated driving vehicle. The vehicle controller is programmed to execute first processing of receiving the terminal camera image from the management server, and second processing of identifying an image area that matches the terminal camera image from an in-vehicle camera image captured by the in-vehicle camera, and to determine a pickup position capable of stopping based on positional coordinates information of the image area.

The ninth disclosure has the following features in the eighth disclosure.

The terminal camera image is a user image obtained by capturing the user. In the second processing, the vehicle controller is programmed to specify the image area as the desired dispatch location where the user is present, and to determine a stoppable position close to the desired dispatch location as the pickup position.

The tenth disclosure has the following features in the eighth disclosure.

The vehicle controller is programmed to further execute third processing of recognizing that the automated driving vehicle has approached the desired dispatch location, and fourth processing of sending a notification to the user terminal to prompt the user to capture the terminal camera image when the automated driving vehicle approaches the desired dispatch location.

The eleventh disclosure is applied to a vehicle dispatching method for an automated driving vehicle capable of driverless transportation, which is connected via a communication network to a user terminal with a terminal camera owned by a user who is at a desired dispatch location. The automated driving vehicle includes an in-vehicle camera to capture a surrounding situation. The vehicle dispatching method includes receiving a terminal camera image, which is captured by the terminal camera at the desired dispatch location, from the user terminal via the communication network, identifying an image area that matches the terminal camera image from an in-vehicle camera image captured by the in-vehicle camera, and determining a pickup position capable of stopping based on positional coordinates information of the image area.

According to the present disclosure, in determining the pickup position by the vehicle controller of the automated driving vehicle, the image area that matches the in-vehicle camera image captured by the in-vehicle camera from the terminal camera image captured at the desired dispatch location by the terminal camera is identified. The positional coordinates information of the image area can be used as information for identifying the desired dispatch location where the user is present. This allows the vehicle controller to determine an appropriate pickup position for the user.

In specifically, according to the second or ninth disclosure, since the user himself/herself at the vehicle desired dispatch location is the imaging target of the terminal camera image, the desired dispatch location can be easily identified from the matching image area.

According to the fourth or tenth disclosure, since the user can be prompted to capture the terminal camera image, the user can recognize the necessity of capturing the image and the timing thereof. Thus, it is possible to prevent the reception delay of the terminal camera image from the user terminal.

Further, according to the seventh disclosure, since the information about the determined pickup position is notified to the user, the user can easily find the dispatched automated driving vehicle.

### BRIEF DESCRIPTION OF DRAWINGS

FIG. 1 is a block diagram schematically showing a configuration of a vehicle dispatching system of an automated driving vehicle according to a present embodiment;

FIG. 2 is a conceptual diagram for explaining an outline of a vehicle dispatching service according to the present embodiment;

FIG. 3 is a block diagram showing a configuration example of the automated driving vehicle according to the present embodiment;

FIG. 4 is a block diagram showing a configuration example of a user terminal according to the present embodiment;

FIG. 5 is a functional block diagram for explaining a function of a vehicle controller of the automated driving vehicle;

FIG. 6 is a flowchart for explaining a flow of the vehicle dispatching service performed by the vehicle dispatching system; and

FIG. 7 is a flowchart for explaining a procedure of a stop preparation processing in the vehicle dispatching service.

### DETAILED DESCRIPTION

Hereinafter, embodiments of the present disclosure will be described with reference to the accompanying drawings. However, it is to be understood that even when the number, quantity, amount, range or other numerical attribute of each element is mentioned in the following description of the embodiment, the present disclosure is not limited to the mentioned numerical attribute unless explicitly described otherwise, or unless the present disclosure is explicitly specified by the numerical attribute theoretically. Furthermore, structures or steps or the like that are described in conjunction with the following embodiment is not necessarily essential to the present disclosure unless explicitly described otherwise, or unless the present disclosure is explicitly specified by the structures, steps or the like theoretically.

### Embodiment

### 1. Vehicle Dispatching System for Automated Driving Vehicle

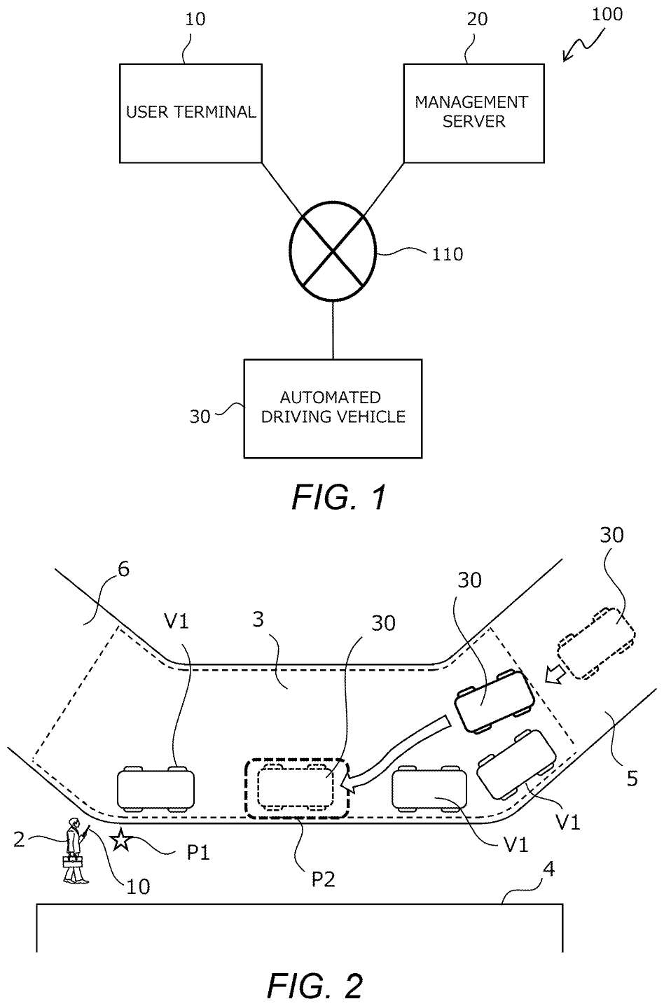

FIG. 1 is a block diagram schematically showing a configuration of a vehicle dispatching system of an automated driving vehicle according to the present embodiment. A vehicle dispatching system 100 provides a vehicle dispatching service for an automated driving vehicle to a user. The vehicle dispatching system 100 includes a user terminal 10, a management server 20, and an automated driving vehicle 30.

The user terminal 10 is a terminal owned by the user of the vehicle dispatching service. The user terminal 10 includes at least a processor, a memory, a communication device, and a terminal camera, and is capable of capturing an image, performing various information processing, and communication processing. For example, the user terminal 10 communicates with the management server 20 and the automated driving vehicle 30 via a communication network 110. A smartphone is exemplified as the user terminal 10.

The management server 20 is a server that mainly manages the vehicle dispatching service. The management server 20 includes at least a processor, a memory, and a communication device, and is capable of performing various kinds of information processing and communication processing. The memory stores at least one program and various data for the vehicle dispatching service. By reading out the program stored in the memory and executing it by the processor, the processor realizes various functions for providing the vehicle dispatching service. For example, the management server 20 communicates with the user terminal 10 and the automated driving vehicle 30 via the communication network 110. The management server 20 manages user information. Further, the management server 20 manages the dispatch of the automated driving vehicle 30 and the like.

The automated driving vehicle 30 is capable of driverless transportation. The automated driving vehicle 30 includes at least a vehicle controller, a communication device, and an in-vehicle camera, and is capable of performing various information processing and communication processing. The automated driving vehicle 30 provides a user with a vehicle dispatching service to the pickup location and a transportation service to the destination. The automated driving vehicle 30 communicates with the user terminal 10 and the management server 20 via the communication network 110.

The basic flow of the vehicle dispatching service for the automated driving vehicle is as follows.

When using the vehicle dispatching service, first, the user transmits a vehicle dispatch request using the user terminal 10. Typically, the user starts a dedicated application at the user terminal 10. Next, the user operates the activated application to input the vehicle dispatch request. The vehicle dispatch request includes a desired dispatch location, a destination location, and the like. For example, the user taps the map displayed on the touch panel of the user terminal 10 to set up and designate the desired dispatch location. Alternatively, the desired dispatch location may be obtained from the location information acquired by using the GPS function of the user terminal 10. The vehicle dispatch request is transmitted to the management server 20 via the communication network 110. The management server 20 selects a vehicle to provide a service to the user from among the automated driving vehicle 30 around the user, and transmits information of the vehicle dispatch request to the selected automated driving vehicle 30. The automated driving vehicle 30 which has received the information of the vehicle dispatch request travels autonomously toward the desired dispatch location. The automated driving vehicle 30 provides a transportation service that autonomously travels toward a destination after the user is boarded at the desired dispatch location.

### 2. Outline of Vehicle Dispatching Service of Present Embodiment

FIG. 2 is a conceptual diagram for explaining an outline of the vehicle dispatching service according to the present embodiment. In a facility 4 such as a station, an airport, or a hotel, there is provided a pick-up and drop-off area 3 in which a user who uses the facility 4 gets out of a vehicle or a user 2 who uses the facility 4 gets into a vehicle. The position and range of the pick-up and drop-off area 3 as well as the location of the facility 4 are registered in the map information referred to by the automated driving vehicle 30. Even if the actual pick-up and drop-off area is not clear, the position and range of the pick-up and drop-off area 3 are clearly defined on the map. The pick-up and drop-off area 3 may be provided in contact with a part of a public road such as a station or an airport, or may be provided on the premises of the facility 4 such as a hotel. In the example shown in FIG. 2, the pick-up and drop-off area 3 is provided on the premises of the facility 4. The pick-up and drop-off area 3 is connected to an approach road 5 that guides vehicles from a public road to the pick-up and drop-off area 3, and an exit road 6 that guides vehicles from the pick-up and drop-off area 3 to the public road. The approach road 5 and the exit route 6 are also registered in the map information.

When the user 2 uses the vehicle dispatching service of the automated driving vehicle 30 in such a pick-up and drop-off area 3, the following problem may occur. That is, the desired dispatch position P1 designated by the user 2 may have deviations in its designated position due to the operation error of the user 2. Further, when the position information of the user terminal 10 is used, there is a possibility that the position information with high accuracy may not be obtained due to the errors of the GPS function. Furthermore, the pick-up and drop-off area 3 may be crowded with a large number of vehicles V1 that are stopping to pick up or drop off. For this reason, the desired dispatch position P1 designated by the user 2 may already have the vehicle V1 with other users getting on or off the vehicle.

Therefore, the vehicle dispatching system 100 according to the present embodiment, when the automated driving vehicle 30 enters the pick-up and drop-off area 3, the vehicle dispatching system 100 switches the operation mode of the automated driving vehicle 30 from the normal driving mode for performing normal automatic operation to the stop preparation mode. In the stop preparation mode, a pickup position P2 close to the user 2 and capable of stopping is determined, taking into account the actual congestion situation of the pick-up and drop-off area 3 for the automated driving vehicle 30 and a waiting position of the user 2. In the following description, this processing is referred to as “stop preparation processing”.

In the stop preparation processing, the vehicle dispatching system 100 provides the user 2 with a capturing instruction of a stop target using a terminal camera 14 of the user terminal 10. In the following description, an image captured by the terminal camera of the user terminal 10 is referred to as a “terminal camera image”.

Typically, the user 2 captures an image of the user itself as the stop target. The captured terminal camera image is sent to the automated driving vehicle 30 via the management server 20. The automated driving vehicle 30 captures a surrounding situation using an in-vehicle camera 36 in the pick-up and drop-off area 3. In the following description, the image captured by the in-vehicle camera of the automated driving vehicle 30 is referred to as an “in-vehicle camera image”. The automated driving vehicle 30 performs a matching processing for searching an image area matching between the in-vehicle camera image and the terminal camera image. This image area is also referred to as a “matching area”.

When the matching area is detected by the matching process, the automated driving vehicle 30 converts the matching area into positional coordinates on the map. In the following description, the positional coordinates are referred to as “matching positional coordinates” and information including the matching positional coordinates is referred to as “positional coordinates information”. The automated driving vehicle 30 determines a target of the pickup position on the road close to the matching positional coordinates based on the positional coordinates information.

When the pickup position P2 is determined by the stop preparation processing, the automated driving vehicle 30 switches the operation mode of the automated driving vehicle 30 from the stop preparation mode to the stop control mode. In the stop control mode, the automated driving vehicle 30 generates a target trajectory to the determined pickup position P2. Then, the automated driving vehicle 30 controls the travel device of the automated driving vehicle 30 so as to follow the generated target trajectory.

According to the stop preparation processing described above, the matching processing is performed based on the terminal camera image and the in-vehicle camera image, in the pick-up and drop-off area 3. This makes it possible to determine an appropriate pickup position that reflects the status of the current pick-up and drop-off area 3.

### 3. Configuration Example of Automated Driving Vehicle

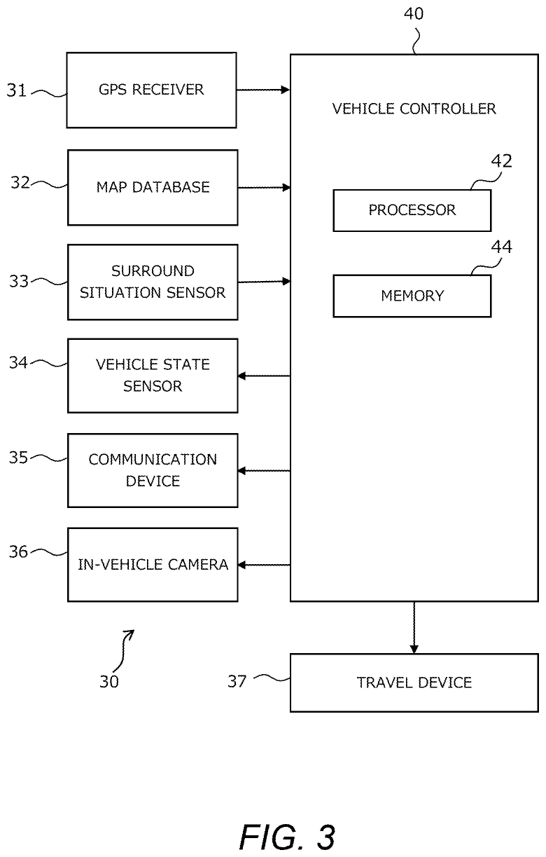

FIG. 3 is a block diagram showing a configuration example of an automated driving vehicle according to the present embodiment. The automated driving vehicle 30 includes a GPS (Global Positioning System) receiver 31, a map database 32, a surround situation sensor 33, a vehicle state sensor 34, a communication device 35, an in-vehicle camera 36, a travel device 37, and a vehicle controller 40. The GPS receiver 31 receives signals transmitted from a plurality of GPS satellites and calculates the position and orientation of the vehicle based on the received signal. The GPS receiver 31 sends the calculated information to the vehicle controller 40.

The map database 32 stores in advance map information such as terrain, roads, signs, and the like, and map information indicating boundary positions of respective lanes of roads on the map. The map database 32 also stores map information about the position and scope of the facility 4 and the pick-up and drop-off area 3. The map database 32 is stored in a memory 44 which will be described later.

The surround situation sensor 33 detects the situation around the vehicle. Examples of the surround situation sensor 33 include a LIDAR (Laser Imaging Detection and Ranging), a radar, and cameras. The rider uses light to detect targets around the vehicle. The radar uses radio waves to detect the landmarks around the vehicle. The surround situation sensor sends the detected information to the vehicle controller 40.

The vehicle state sensor 34 detects traveling conditions of the vehicle. As the vehicle state sensor 34, a lateral acceleration sensor, a yaw rate sensor, a vehicle speed sensor or the like is exemplified. The lateral acceleration sensor detects the lateral acceleration acting on the vehicle. The yaw rate sensor detects the yaw rate of the vehicle. The vehicle speed sensor detects the vehicle speed of the vehicle. The vehicle state sensor 34 sends the detected information to the vehicle controller 40.

The communication device 35 communicates with the outside of the automated driving vehicle 30. Specifically, the communication device 35 communicates with the user terminal 10 through the communication network 110. The communication device 35 communicates with the management server 20 through the communication network 110.

The in-vehicle camera 36 captures a surrounding situation of the automated driving vehicle 30. The type of the in-vehicle camera 36 is not limited.

The travel device 37 includes a driving device, a braking device, a steering device, a transmission, and the like. The driving device is a power source that generates a driving force. As the driving device, an engine or an electric motor is exemplified. The braking device generates braking force. The steering device steers wheels. For example, the steering device includes an electric power steering (EPS: Electronic Power Steering) system. By driving and controlling the motor of the electric power steering system, the wheels is steered.

The vehicle controller 40 performs automated driving control for controlling the automated driving of the automated driving vehicle 30. Typically, the vehicle controller 40 includes one or more ECU (Electronic Control Unit). The ECU includes at least one processor 42 and at least one memory 44. The memory 44 stores at least one program for automated driving and various data. The map information for the automated driving is stored in the memory 44 in the form of a database, or is acquired from a database of the memory 22 of the management server 20 and temporarily stored in the memory 44. The program stored in the memory 44 is read and executed by the processor 42, whereby the automated driving vehicle 30 realizes various functions for automated driving. Typically, the automated driving vehicle 30 provides the user with a vehicle dispatching service to the desired dispatch location and a transportation service to the destination. The automated driving vehicle 30 controls driving, steering, and braking of the vehicle to travel along the set target trajectory. There are various known methods for the automated driving, and in the present disclosure, the method of the automatic operation itself is not limited, and therefore, a detailed description thereof is omitted. The automated driving vehicle 30 communicates with the user terminal 10 and the management server 20 via the communication network 110.

### 4. Example of Configuration of User Terminal

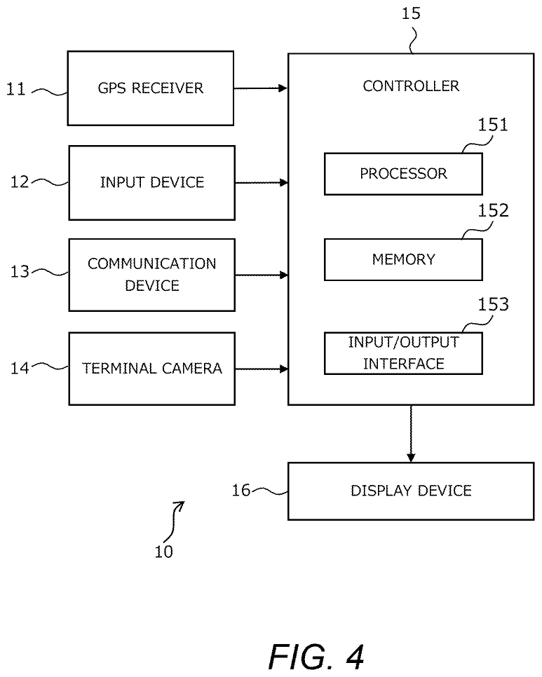

FIG. 4 is a block diagram showing a configuration example of a user terminal according to the present embodiment. The user terminal 10 includes a GPS (Global Positioning System) receiver 11, an input device 12, a communication device 13, a terminal camera 14, a controller 15, and a display device 16. The GPS receiver 11 receives signals transmitted from a plurality of GPS satellites and calculates the position and orientation of the user terminal 10 based on the received signal. The GPS receiver 11 transmits the calculated information to the controller 15.

The input device 12 is a device for users to input information and also for users to operate the application. Examples of the input device 12 include a touch panel, switches, and buttons. The user inputs the vehicle dispatch request, for example, using the input device 12.

The communication device 13 communicates with the outside of the user terminal 10. Specifically, the communication device 13 communicates with the automated driving vehicle 30 via the communication network 110. The communication device 13 communicates with the management server 20 via the communication network 110.

The display device 16 is a device for displaying images or letters. As the display device 16, a touch panel display is exemplified.

The controller 15 is a user terminal controller for controlling various operations of the user terminal 10. Typically, the controller 15 is a microcomputer with a processor 151, a memory 152, and an input/output interface 153. The controller 15 is also referred to as an Electronic Control Unit. The controller 15 receives various information through the input/output interface 153. The processor 151 of the controller 15 performs various functions for various operations of the user terminal 10 by reading and executing the program stored in the memory 152 based on the received information.

### 5. Function of Vehicle Controller of Automated Driving Vehicle

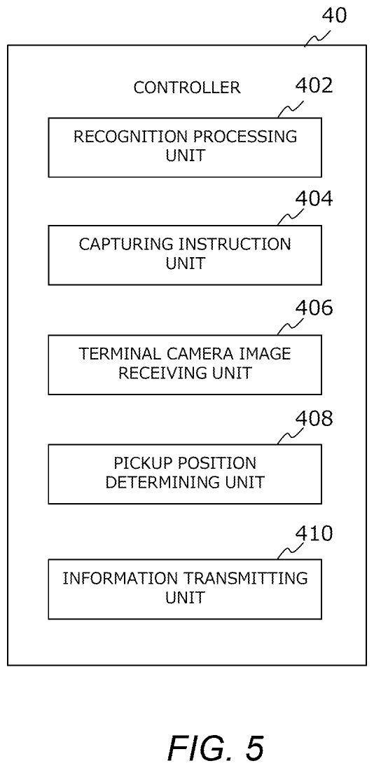

FIG. 5 is a functional block diagram for explaining a function of the vehicle controller of the automated driving vehicle. As shown in FIG. 5, the vehicle controller 40 includes a recognition processing unit 402, a capturing instruction unit 404, a terminal camera image receiving unit 406, a pickup position determining unit 408, and an information transmitting unit 410 as functions for performing a vehicle dispatching service. Note that these functional blocks do not exist as hardware. The vehicle controller 40 is programmed to perform the functions illustrated by the blocks in FIG. 5. More specifically, when a program stored in the memory 44 is executed by the processor 42, the processor 42 performs processing related to these functional blocks. The vehicle controller 40 has various functions for automated driving and advanced safety in addition to the functions shown in the block in FIG. 5. However, since known techniques can be used for automated driving and advanced safety, their descriptions are omitted in the present disclosure.

The recognition processing unit 402 executes a recognition processing for recognizing that the automated driving vehicle 30 has approached the desired dispatch position P1. Typically, in the recognition processing, it is recognized that the automated driving vehicle 30 has entered the pick-up and drop-off area 3. The position and range of the pick-up and drop-off area 3 are included in the map information. Therefore, by comparing the position of the automated driving vehicle 30 acquired by the GPS receiver 31 with the position and range of the pick-up and drop-off area 3, it is possible to determine whether or not the automated driving vehicle 30 has entered the pick-up and drop-off area 3. If the pick-up and drop-off area 3 is not included in the map information, for example, information for distinguishing the inside and outside of the pick-up and drop-off area 3 may be obtained from the image captured by the in-vehicle camera 36. Further, if radio waves are emitted from the infrastructure facility, it may be determined whether it has entered the pick-up and drop-off area 3 from the intensity of the radio waves.

In another example of the recognition processing in the recognition processing unit 402, it recognizes that the automated driving vehicle 30 has approached a predetermined distance predetermined from the desired dispatch position P1. Here the predetermined distance is a distance which is set in advance as a recognizable distance of the surrounding environment of the user 2 waiting by the in-vehicle camera 36 and various sensors automated driving vehicle 30 is provided. The desired dispatch position P1 is specified on the basis of the map information. Therefore, by calculating the distance from the position of the automated driving vehicle 30 obtained by the GPS receiver 31 to the position of the desired dispatch position P1, it is possible to determine whether the distance between the desired dispatch position P1 and the automated driving vehicle 30 has reached a predetermined distance.

When the automated driving vehicle 30 recognizes that approaches the desired dispatch position P1 in the recognition processing, the capturing instruction unit 404 executes a capturing instruction processing to prompt the capturing of a stop target to the user 2. Typically, in the capturing instruction processing, the capturing instruction unit 404 transmits a notification for prompting the user terminal 10 held by the user 2 to capture an image by the terminal camera 14 via the management server 20. An example of such a notification is a message saying “Please capture a stop target with a camera”.

The terminal camera image receiving unit 406 executes a terminal camera image receiving processing for receiving a terminal camera image captured by the terminal camera 14 of the user terminal 10. Typically, the terminal camera image is an image obtained by capturing the user itself located in the desired dispatch position P1. This camera image is hereinafter referred to as a “user image”. The user image is an image of a part of the user 2, e.g., a face, or the whole body. The terminal camera image received by the terminal camera image receiving processing is stored in the memory 44.

The pickup position determining unit 408 executes a determination processing of determining a final pickup position P2 for picking up the user 2, based on the terminal camera image and the in-vehicle camera image. Typically, the pickup position determining unit 408 performs a matching processing of searching the matching area between the in-vehicle camera image and the terminal camera image. When the matching area is detected by the matching processing, the pickup position determining unit 408 converts the matching area into the matching positional coordinates on the map. When the terminal camera image is a user image, the matching positional coordinates correspond to the positional coordinates of the user 2. Then, the pickup position determining unit 408 determines the stoppable position closest to the matching positional coordinates to the pickup position P2, based on the information obtained from the surround situation sensor 33 and the in-vehicle camera 36. The determined pickup position P2 is stored in the memory 44.

The information transmitting unit 410 executes information notifying processing of transmitting the information on the pickup position P2 decided by the determination processing to the user terminal 10 held by the user 2 via the management server 20. The information transmitted by the information notification processing includes not only the determined pickup position P2 but also information to that effect when the feasible pickup position P2 is not found. The transmitted information is displayed on the display device 16 of the user terminal 10.

### 6. Specific Processing of Vehicle Dispatching Service

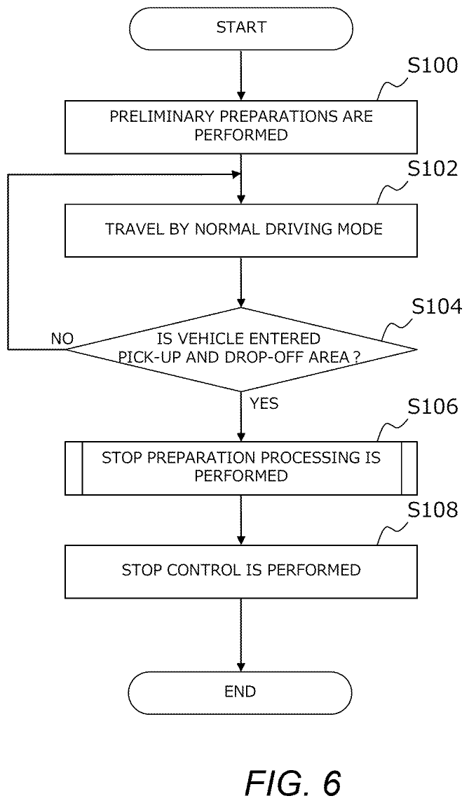

The vehicle dispatching system 100 provides a vehicle dispatching service of the automated driving vehicle 30 to the user 2 by transmitting and receiving various types of information between the user terminal 10, the management server 20, and the automated driving vehicle 30 via the communication network 110. FIG. 6 is a flowchart for explaining a flow of the vehicle dispatching service performed by the vehicle dispatching system.

In step S100, preliminary preparations are performed in the vehicle dispatching service. Here, the management server 20 receives the vehicle dispatch request from the user terminal 10 of the user 2 via the communication network 110. The vehicle dispatch request includes a desired dispatch position P1, a destination, and the like. The management server 20 selects a vehicle to provide a service to the user 2 from among the automated driving vehicle 30 around the user 2, and transmits information of the vehicle dispatch request to the selected automated driving vehicle 30.

In step S102, upon receiving the information of the vehicle dispatch request, the automated driving vehicle 30 travels autonomously by the normal driving mode toward the desired dispatch location P1. Typically, in a normal driving mode, the vehicle controller 40 generates the target trajectory to the desired dispatch position P1 based on the map information and the position and velocity information of the surrounding objects acquired by the sensor. The vehicle controller 40 controls the travel device 37 of the automated driving vehicle 30 so that the automated driving vehicle 30 follows the generated target trajectory.

Next in step S104, it is determined whether the automated driving vehicle 30 has approached the desired dispatch position P1 by the recognition processing. Typically, the recognition processing determines whether the automated driving vehicle 30 has entered the pick-up and drop-off area 3. This determination is performed in a predetermined cycle until the determination is established. During that time, in the step S102, the automated driving by the normal driving mode is continued. When the automated driving vehicle 30 approaches the desired dispatch position P1, the procedure proceeds to the next step S106.

Next in step S106, the operation mode of the automated driving vehicle 30 is switched from the normal driving mode to the stop preparation mode. In the stop preparation mode, a stop preparation processing is performed. Details of the stop preparation processing will be described later with reference to a flowchart.

Once the pickup position P2 is determined by the stop preparation processing, the procedure proceeds to the next step S108. In the step S108, stop control of the automated driving vehicle 30 is performed. In the stop control, the automated driving vehicle 30 is stopped at the pickup position P2 by controlling the travel device 37.

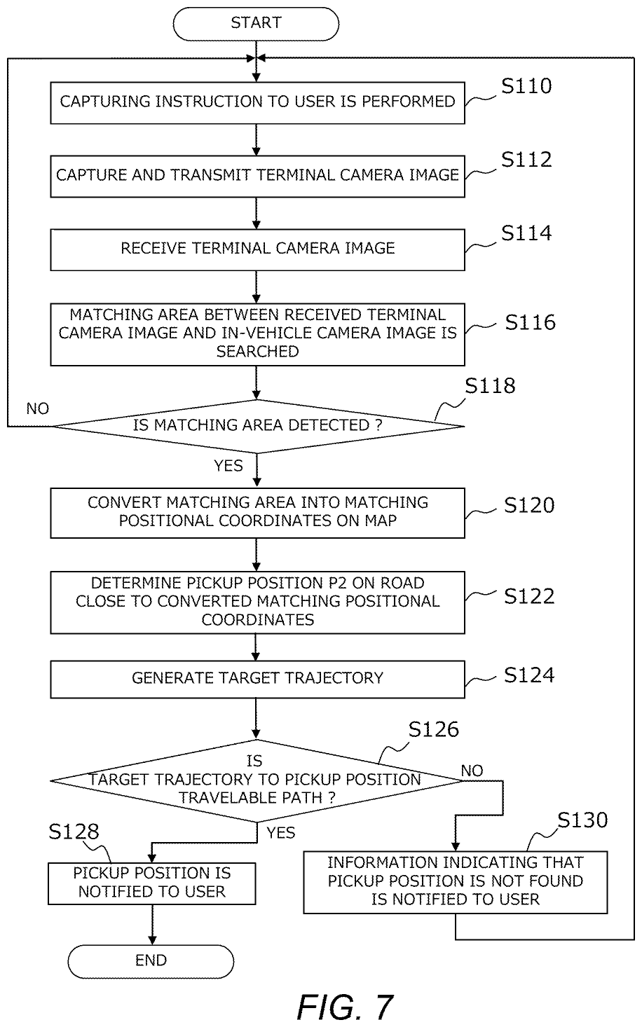

FIG. 7 is a flowchart for explaining a procedure of the stop preparation processing in the vehicle dispatching service. When the operation mode of the automated driving vehicle 30 is switched from the normal operation mode to the stop preparation mode, the stop preparation processing shown in FIG. 7 is executed. In step S110, in the stop preparation processing, a capturing instruction is performed to the user 2 by the capturing instruction processing. In step S112, the user 2 at the desired dispatch location captures the user's own face as the stop target by using the terminal camera 14 of the user terminal 10. The controller 15 of the user terminal 10 executes a terminal camera image transmission processing for transmitting the terminal camera image to the automated driving vehicle 30 via the communication network 110. In the next step S114, the terminal camera image is received by the terminal camera image receiving processing.

In the next step S116, the matching area between the received terminal camera image and the in-vehicle camera image is searched for by the matching processing. In the next step S118, it is determined whether the matching area is detected by the matching processing. As a result of the determination, when the matching area is not detected, the process returns to the step S110, and the image capturing instruction processing is executed again.

On the other hand, when the matching area is detected as a result of the determination of the step S118, the process proceeds to the next step S120. In the step S120, the detected matching area is converted into the matching positional coordinates on the map. In the next step S122, the pickup position P2 is determined on the road close to the converted matching positional coordinates in the determination processing. In the next step S124, the target trajectory is generated to the pickup position P2. Typically, the vehicle controller 40 generates the target trajectory from the current position of the automated driving vehicle 30 acquired at the GPS receiver 31 to the pickup position P2.

In the next step S126, it is determined whether the target trajectory to the pickup position P2 is a travelable path. Typically, it is determined whether the generated target trajectory is a feasible path based on the surrounding situation of the pick-up and drop-off area 3 obtained from the surround situation sensor 33 and the in-vehicle camera 36. As a result, when it is determined that the generated target trajectory can be realized, the process proceeds to step S128, and when it is determined that it cannot be realized, the process proceeds to step S130.

In step S128, the information of the pickup position P2 is notified to the user 2 by the information notification processing. When the process of the step S128 is completed, the stop preparation processing is terminated.

On the other hand, in step S130, information indicating that the pickup position P2 is not found is notified to the user 2 by the information notification processing. When the process of step S130 is completed, the stop preparation processing returns to step S110, and the capturing instruction processing is executed again.

According to the stop preparation processing described above, by performing the matching processing between the terminal camera image and the in-vehicle camera image in the pick-up and drop-off area 3, it is possible to determine an appropriate pickup position that reflects the current situation in the pick-up and drop-off area 3.

### 7. Modified Examples

The vehicle dispatching system 100 according to the present embodiment may adopt a modified mode as described below.

Part of the functions of the vehicle controller 40 may be disposed in the management server 20 or the user terminal 10. For example, the recognition processing unit 402, the capturing instruction unit 404, the terminal camera image receiving unit 406, the pickup position determining unit 408, or the information transmitting unit 410 of the vehicle controller 40 may be disposed in the management server 20. In this case, the management server 20 may acquire necessary information via the communication network 110.

The stopping target of capturing the terminal camera image is not limited to the user itself. For example, the terminal camera image may include a fixed target such as a landmark as a stop target. Further, if the capturing time of the terminal camera image and the in-vehicle camera image is at the same time, the stop target is a person, dogs, may be a movement target such as other vehicles.

The terminal camera image may include a surrounding image for calculating the location of the user who is the target of the stop, rather than the stop target itself. In this case, in the imaging instruction processing, the capturing instruction unit 404 sends a notification that, for example, “please capture an image of the periphery while slowly moving the camera”. The user captures an image of the surrounding environment of a desired vehicle dispatching location where the user is located in accordance with the image capturing instruction. This terminal camera image is called “surrounding environment image”. The pickup position determining unit 408 searches the matching area between the surrounding environment image and the in-vehicle camera image in the matching processing, and converts the matching area to the matching positional coordinates. Then, in the determination processing, the pickup position determining unit 408 specifies the positional coordinates of the desired dispatch location where the user is located, based on the matching positional coordinates, and determines the position where the vehicle can stop close to the specified desired dispatch location as the pickup position. According to such a process, even if the stop target directly to the terminal camera image is not captured, it is possible to appropriately determine the pickup position.

In the dispatch preparation mode to be executed in the automated driving vehicle 30, it may also be performed simultaneously vehicle control of the automated driving vehicle 30 that is suitable to facilitate searching the matching area in the stop preparation processing. Such processing can be realized, for example, by further including a speed control unit which controls the speed of the automated driving vehicle 30 as a functional block of the vehicle controller 40. In this case, the speed control unit may control the maximum allowable speed of the automated driving vehicle 30 to a predetermined speed lower than that in the normal driving mode in the dispatch preparation mode. The predetermined speed may be less than 15 km/h, for example. Further, in consideration of the sensor detectable distance such as the surround situation sensor 33, the predetermined speed may be set to a speed at which the vehicle can stop within a predetermined time at a predetermined deceleration relative to the sensor detection distance, for example.

In addition, the traveling position of the automated driving vehicle 30 in the lane may be varied to ensure smooth movement of the vehicle within the pick-up and drop-off area 3. Typically, the vehicle controller 40 of the automated driving vehicle 30 generates the target trajectory to travel to the left in the lane rather than in the normal driving mode in the dispatch preparation mode, causing the automated driving vehicle 30 to travel. Thus, since the overtaking of the subsequent vehicle of the automated driving vehicle 30 is facilitated, it is possible to ensure smooth traffic in the pick-up and drop-off area 3.

What is claimed is:

1. A vehicle controller for an automated driving vehicle capable of driverless transportation, which is connected via a communication network to a user terminal with a terminal camera owned by a user who is at a desired dispatch location, the automated driving vehicle comprising an in-vehicle camera to capture a surrounding situation, the vehicle controller comprising:
at least one processor; and
at least one memory including at least one program that causes the at least one processor to execute:
first processing of receiving a terminal camera image, which is captured by the terminal camera at the desired dispatch location, from the user terminal via the communication network;
second processing of identifying an image area that matches the terminal camera image from an in-vehicle camera image captured by the in-vehicle camera, and determining a pickup position capable of stopping based on positional coordinates information of the image area.

2. The vehicle controller for the automated driving vehicle according to claim 1,
wherein, the terminal camera image is a user image obtained by capturing the user, and
wherein, in the second processing, the at least one program causes the at least one processor to specify the image area as the desired dispatch location where the user is present, and to determine a stoppable position close to the desired dispatch location as the pickup position.

3. The vehicle controller for the automated driving vehicle according to claim 1,
wherein, the terminal camera image is a surrounding environment image obtained by capturing a surrounding environment of the desired dispatch location, and
wherein, in the second processing, the at least one program causes the at least one processor to specify the desired dispatch location based on positional coordinate information of the image area, and to determine a stoppable position close to the desired dispatch location as the pickup position.

4. The vehicle controller for the automated driving vehicle according to claim 1,
wherein, the at least one program causes the at least one processor to execute:
third processing of recognizing that the automated driving vehicle has approached the desired dispatch location, and
fourth processing of sending a notification to the user terminal to prompt the user to capture the terminal camera image when the automated driving vehicle approaches the desired dispatch location.

5. The vehicle controller for the automated driving vehicle according to claim 4,
wherein, in the third processing, the at least one program causes the at least one processor to recognize that the automated driving vehicle approaches the desired dispatch location when the automated driving vehicle enters a pick-up and drop-off area used by the user.

6. The vehicle controller for the automated driving vehicle according to claim 4,
wherein, the at least one program causes the at least one processor to execute fifth processing of reducing a maximum allowable speed of the automated driving vehicle compared to before approaching the desired dispatch location, when the automated driving vehicle approaches the desired dispatch location.

7. The vehicle controller for the automated driving vehicle according to claim 1,
wherein, the at least one program causes the at least one processor to execute sixth processing of transmitting information related to the pickup position to the user terminal.

8. A vehicle dispatching system comprising:
an automated driving vehicle capable of driverless transportation;
a user terminal owned by a user who is at a desired dispatch location; and
a management server to communicate with the automated driving vehicle and the user terminal via a communication network,
wherein, the user terminal comprises:
a terminal camera, and
a user terminal controller to control the user terminal,
wherein the user terminal controller is programmed to execute processing of transmitting a terminal camera image, which is captured by the terminal camera at the desired dispatch location, to the management server,
wherein the automated driving vehicle comprises:
an in-vehicle camera to capture a surrounding situation of the automated driving vehicle, and
a vehicle controller to control the automated driving vehicle,
wherein the vehicle controller is programmed to execute:
first processing of receiving the terminal camera image from the management server, and
second processing of identifying an image area that matches the terminal camera image from an in-vehicle camera image captured by the in-vehicle camera, and to determine a pickup position capable of stopping based on positional coordinates information of the image area.

9. The vehicle dispatching system according to claim 8,
wherein the terminal camera image is a user image obtained by capturing the user, and
wherein, in the second processing, the vehicle controller is programmed to specify the image area as the desired dispatch location where the user is present, and to determine a stoppable position close to the desired dispatch location as the pickup position.

10. The vehicle dispatching system according to claim 8,
wherein, the vehicle controller is programmed to further execute:
third processing of recognizing that the automated driving vehicle has approached the desired dispatch location, and
fourth processing of sending a notification to the user terminal to prompt the user to capture the terminal camera image when the automated driving vehicle approaches the desired dispatch location.

11. A vehicle dispatching method for an automated driving vehicle capable of driverless transportation, which is connected via a communication network to a user terminal with a terminal camera owned by a user who is at a desired dispatch location,
wherein, the automated driving vehicle includes an in-vehicle camera to capture a surrounding situation,
wherein, the vehicle dispatching method comprises:
receiving a terminal camera image, which is captured by the terminal camera at the desired dispatch location, from the user terminal via the communication network,
identifying an image area that matches the terminal camera image from an in-vehicle camera image captured by the in-vehicle camera, and
determining a pickup position capable of stopping based on positional coordinates information of the image area.
